(19) United States
(12) Patent Application Publication
(10) Pub. No.: US 2006/0117707 A1
(43) Pub. Date: Jun. 8, 2006

(54) Apparatus for producing core assemblies

(75) Inventors: Jurgen Beyerer, Dielheim (DE); Thomas Winkel, Bruhl (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Hottinger Maschinenbau GmbH

(21) Appl. No.: 11/339,021

(22) Filed: Jan. 25, 2006

Related U.S. Application Data
(63) Continuation of application No. PCT/DE04/01707, filed on Jul. 30, 2004.

(30) Foreign Application Priority Data
Aug. 7, 2003 (DE) 103 36 917.1

(51) Int. Cl. B08B 3/00

(52) U.S. Cl. 53/154; 53/168; 134/64 R

(57) ABSTRACT

An apparatus for producing core assemblies that are used in particular for casting engine blocks and cylinder heads in a foundry. The apparatus includes a shooting station in which the individual cores are shot in a tool (3), and a withdrawal station (1) from which the cores are taken out and transferred for assembly to an assembly line (2). Different cores can be produced with different tools (3), and manipulators (4, 5, 6) are associated to the assembly line for taking the cores out of the opened tools (3), for handling and/or treating the cores, and finally for assembling and removing the resulting core assemblies.

### CROSS REFERENCE TO RELATED APPLICATION

The present application is a continuation of international application PCT/DE2004/001707, filed 30 Jul., 2004, and which designates the U.S. The disclosure of the referenced application is incorporated herein by reference.

### BACKGROUND OF THE INVENTION

The present invention relates to an apparatus for producing core assemblies that are used in particular for casting engine blocks and cylinder heads, with a shooting station, in which the individual cores are shot, and with a withdrawal station, from which the shot cores are removed and transferred for assembly to an assembly line, wherein different cores can be produced with different tools.

Quite generally, the invention relates to the production of cores, which are completed to a core assembly. The core assembly is used as a mold in the foundry practice, wherein for casting molded parts of any type, foundry cores or foundry molds are generally made as separate parts, combined and joined together to form a casting mold or a core or mold assembly. These core assemblies are subsequently filled with molten metal for producing, for example, a metallic workpiece. In mass production, the core assemblies to be filled with molten metal pass one after the other through the production line.

Core and shell shooting machines for producing cores that are to be joined, have been known from practical operation for decades, for example, from DE 31 48 461 C1, which discloses a core and shell shooting machine.

In the known core and shell shooting machine, individual cores are produced and transported in a conventional manner to a downstream assembly station, which also receives cores from other shooting stations. Regardless of the shooting station, the core assembly is there put together in a plurality of operating steps. This is time-consuming and burdensome from the viewpoint of handling, and an automatic production is not possible.

It is therefore an object of the present invention to improve and further develop a generic apparatus for producing core assemblies that are used in particular for casting engine blocks and cylinder heads, in such a manner that it permits an automatic production of complete core assemblies with the smallest possible space requirement, in particular also when the shooting station produces or makes available different cores.

### SUMMARY OF THE INVENTION

The above and other objects and advantages of the invention are achieved by the provision of an apparatus for producing core assemblies wherein an assembly line for completing the core assemblies is arranged adjacent the shooting station or the subsequent withdrawal station, and wherein the assembly line includes a plurality of manipulators for taking the core out of the opened tool, for handling and/or treating the cores, and finally for putting together and removing the core assemblies. Where the cores are produced with different tools, the cores are taken out of the tools and delivered to a withdrawal station in a sequence of need, and they are then delivered to the downstream assembly line where they can there be handled in any desired way. Specifically, they can be completed to a core assembly, and finally be removed.

To take out the core in an advantageous manner when the tool is opened in the withdrawal station, it is possible to extend the lower tool component and to eject the core therefrom. After having been ejected, the core can be delivered to the downstream assembly line and be handled by means of the manipulators. Specifically, one could provide a fork-type removing device for taking out the core. The removal of the core may basically occur by means of a manipulator, which transfers the core to the assembly line after removing it from the tool.

Likewise, it is possible to provide a pallet-type removing device for transferring the cores to the assembly line. Such a pallet-type removing device comprises core specific pallets with correspondingly formed receptacles for a particular core. Thus, the core is directly removed from the tool and placed onto the pallet. Because of the receptacles, it is possible to adjust the core in its position, whereby an automatic treatment in downstream treatment stations is simplified.

As aforesaid, the particular core can be placed onto the core specific pallet, transferred to the assembly line together with the pallet, and advanced along the assembly line. In an advantageous manner, the assembly line comprises a linear conveyor for the pallets or cores. Specifically, the linear conveyor could form a closed loop conveying line around the withdrawal station, so that the pallets with the particular cores thereon are advanced along the treatment stations, and are removed in a suitable point for completing the core assembly. Because of the closed loop conveying line, the vacated pallets are again returnable to the withdrawal station, so that the pallets circulate altogether along the conveying line. After removing the particular core, it is possible to schedule the pallet for cleaning. To this end, the pallet could travel through a cleaning station that is specially provided for this purpose.

The cores on the pallets advance through different treatment stations, and are finally removed for completing the core assembly downstream of a preferably centrally arranged assembly station. The removal occurs by means of a manipulator, which combines the cores at the assembly station.

On the way toward the assembly station, additional manipulators are arranged in a further advantageous manner along the linear conveyor for purposes of being able to handle the cores for different purposes. These manipulators may be arranged on one side, preferably on the outer side of the linear conveyor. Likewise, it is possible to position manipulators on both sides of the linear conveyor for purposes of minimizing paths and with that cycle times.

As earlier indicated, it is possible to arrange treatment stations along the linear conveyor. These treatment stations comprise at least one deburring station for removing burrs from the individual cores. It is likewise possible to provide a cleaning station for cleaning or blowing out the cores.

In a particularly advantageous manner, the treatment stations comprise a special inserting station, for inserting externally produced cores, or core components, or other parts. These may include, for example, a sleeve that is to be positioned on the core and be secured thereto in addition. By means of the manipulators, it is possible to provide a great variety of treatments.

Likewise, it is possible to provide along the assembly line, a supply station for bringing in cores from storage or an associated core shooting line. This supply of external cores could very advantageously be used to replace a specific core type, whose tools must be taken out for purposes of cleaning or repair. At any rate, it would be possible to supply the assembly line via a kind of core reservoir, if need be. Furthermore, it is possible to supply from outside very small core components, which do not fit into the particular production because of the core type.

Furthermore, it is possible to provide along the assembly line an additional supply station or the above described supply station for special purposes, i.e., for introducing core units that have been preassembled outside the assembly line. With that, it is possible to combine especially small cores outside the actual assembly line, and to introduce them in combination.

The actual completion of the core assembly occurs at the assembly station. For a better handling, in particular with respect to a simple operation by the manipulators, the assembly station comprises a turntable. The rotation of the turntable could occur automatically in adaptation to the respective core position and the manipulators required for handling. Likewise in this instance, it is possible to optimize paths. To this end, a very special control system is provided. Advantageously, the turntable can be endlessly rotated, i.e., about 360°, so as to permit an optimal adaptation to the particular circumstances.

Finally, for removing the finished core assembly, preferably from the foregoing turntable, a further manipulator is provided, which takes the completed core assembly out of the actual assembly line and advances it, if necessary, to additional treatment stations.

There exist various possibilities of improving and further developing the teaching of the present invention in an advantageous manner. To this end, reference may be made to the following description of a preferred embodiment of the invention with reference to the drawing. In conjunction with the description of the preferred embodiment with reference to the drawing, also generally preferred improvements and further developments of the teaching are described.

### BRIEF DESCRIPTION OF THE DRAWING

FIG. 1 is a schematic and fragmentary view of an apparatus according to the invention, which illustrates for the sake of simplicity only the assembly line for completing the core assembly downstream of the core production.

### DETAILED DESCRIPTION OF THE PREFERRED EMBODIMENT

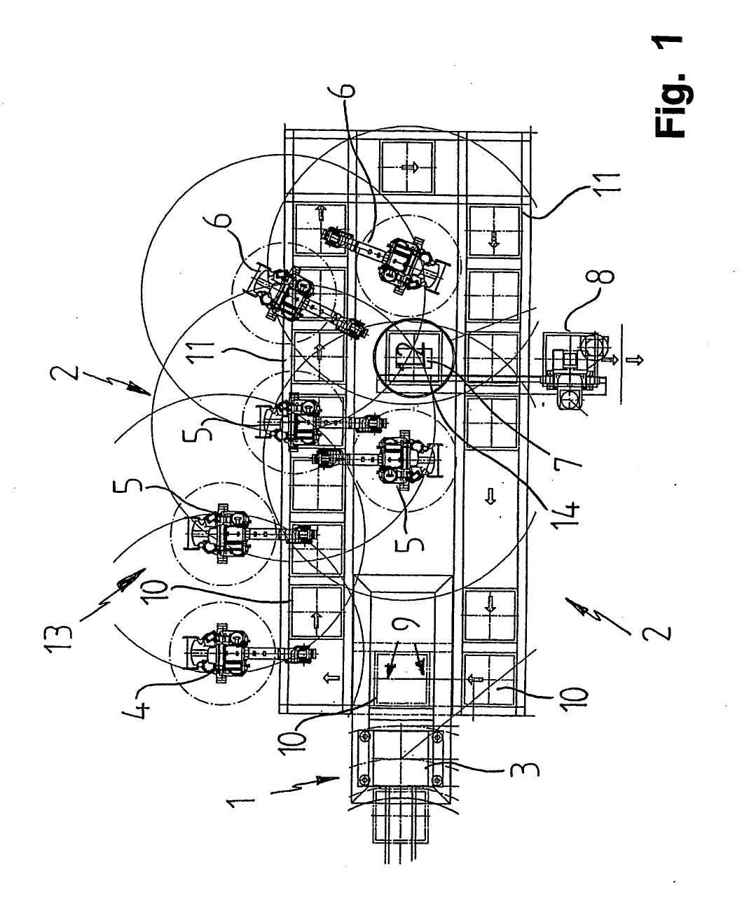

As seen in FIG. 1, shot cores are made available in a withdrawal station 1 after the actual core production. From this withdrawal station 1, a manipulator removes the cores and transfers them for assembling to an assembly line 2. In this process, it is important that cores produced with different tools 3 can be removed from the withdrawal station 1 exactly in the sequence, in which they are needed for putting together the core assembly.

In accordance with the invention, different manipulators are associated to the assembly line 2, i.e., a manipulator 4 for taking the core out of the opened tool 3, manipulators 5 for handling and/or treating the cores, and finally manipulators 6 for putting together a core assembly 7, and a manipulator 8 for removing the completed core assembly 7.

As indicated in FIG. 1, the closed cores are transferred in the withdrawal station 1 by means of manipulator 4 to the assembly line 2. There, a pallet removing device 9 is provided, which comprises pallets 10 with core specific receptacles for the particular core. Accordingly, the core can be placed on the core specific pallet 10, be transferred to the assembly line 2, and advanced therealong together with the pallet 10.

The assembly line 2 comprises a linear conveyor 11 for the pallets 10 or the cores positioned thereon. The linear conveyor 11 forms a closed loop conveying line around the withdrawal station 1, so that the pallets 10 circulate from the withdrawal station 1, via the respective treatment stations, back to the withdrawal station 1.

As also indicated in FIG. 1, the pallets 10 with the cores thereon can be advanced to a centrally located assembly station 12, with the further manipulators 5 and 6 being arranged along the linear conveyor 11. These manipulators 5, 6 are positioned on both sides of the linear conveyor 11, with different treatment stations 13 being provided along the linear conveyor 11. These treatment stations can include deburring devices, an inserting station for inserting externally produced cores or other parts, a supply station for bringing in cores from storage, or however also a supply station for core units that have been preassembled outside of the assembly line, or the like.

The assembly station 12 comprises a turntable 14 for receiving the cores or completing the core assembly. The there completed core assembly 7 is removed from the assembly line 2 by means of a further manipulator 8, and can be advanced from there to further treatment stations or the foundry.

With respect to further advantageous configurations that are not shown in FIG. 1, the general part of the specification is herewith incorporated by reference for purposes of avoiding repetitions.

Many modifications and other embodiments of the invention set forth herein will come to mind to one skilled in the art to which the invention pertains having the benefit of the teachings presented in the foregoing description and the associated drawing. Therefore, it is to be understood that the invention is not to be limited to the specific embodiment disclosed and that modifications and other embodiments are intended to be included within the scope of the appended claims. Although specific terms are employed herein, they are used in a generic and descriptive sense only and not for purposes of limitation.

1. An apparatus for producing core assemblies useful in foundry operations, comprising
a shooting station having at least one tool in which individual cores are shot,
an assembly line positioned adjacent the shooting station, and
a plurality of manipulators associated with the assembly line for removing the cores from the associated tool and transferring the cores to the assembly line, for handling and/or treating the cores along the assembly line, for assembling the cores to form core assemblies, and for removing the resulting core assemblies from the assembly line.

2. The apparatus of claim 1, wherein the at least one tool comprises upper and lower components which are openable so as to permit removal of the core formed therein, and wherein the lower tool component can be extended so that the core can be ejected from the lower tool component.

3. The apparatus of claim 1, wherein one of the manipulators comprises a fork type removing device for taking the core out of the associated tool.

4. The apparatus of claim 1, wherein one of the manipulators is configured to transfer a core which has been removed from its associated tool, to the assembly line.

5. The apparatus of claim 1, further comprising a plurality of pallets which are each configured to receive a core at a withdrawal station, and a pallet moving device for transferring the pallets and associated cores to and along the assembly line.

6. The apparatus of claim 5, wherein the pallets have core specific receptacles configured for a particular core.

7. The apparatus of claim 6, wherein a particular core can be placed onto the core specific pallet and be transferred together with the pallet to the assembly line and be advanced therealong.

8. The apparatus of claim 1, wherein the assembly line comprises a conveyor for the cores or pallets supporting the cores.

9. The apparatus of claim 8, wherein the conveyor forms a closed loop conveying line which includes a withdrawal station at which the cores are received from the associated tool, and wherein vacated pallets can be advanced to the withdrawal station and be re-circulated.

10. The apparatus of claim 9 further comprising an assembly station centrally arranged within the closed loop conveying line and to which the cores or pallets supporting the cores can be advanced.

11. The apparatus of claim 10, wherein the further manipulators are arranged along the closed loop conveying line.

12. The apparatus of claim 11, wherein the manipulators are positioned on one side, or on both sides of the closed loop conveying line.

13. The apparatus of claim 8, wherein treatment stations are provided for the cores along the conveyor.

14. The apparatus of claim 13, wherein the treatment stations comprise at least one deburring device.

15. The apparatus of claim 14, wherein the treatment stations further comprise an inserting station for inserting externally produced cores or other parts.

16. The apparatus of claim 1, further comprising a supply station along the assembly line for bringing in cores from storage or an associated core shooting line.

17. The apparatus of claim 1, further comprising a supply station along the assembly line for bringing in core units that are preassembled outside the assembly line.

18. The apparatus of claim 10, wherein the assembly station comprises a turntable that is rotatable about 360° for facilitating the core assembly operation thereon.

19. The apparatus of claim 18, wherein one of the manipulators is configured for removing the completed core assemblies from the turntable.

20. The apparatus of claim 1, wherein the shooting station comprises a plurality of tools which are configured to shoot differing individual cores, and wherein one of the manipulators is configured for removing the cores from the tools in a selected sequence.
